(19) United States
(12) Patent Application Publication
(10) Pub. No.: US 2019/0363747 A1
(43) Pub. Date: Nov. 28, 2019

(54) SMART PHONE CASE ASSEMBLY

(71) Applicant: Guadalupe Ramon Gil Vera, Portland, OR (US)

(72) Inventor: Guadalupe Ramon Gil Vera, Portland, OR (US)

(21) Appl. No.: 15/987,034

(22) Filed: May 23, 2018

(51) Int. Cl. H04B 1/3888; A45C 11/00

(52) U.S. Cl. CPC H04B 1/3888; A45C 2011/002; A45C 11/00

(57) ABSTRACT

A smart phone case assembly for retaining a smart phone case on a user's fingers includes a case that has an electronic device removably positioned therein. The case is comprised of a rigid material to protect the electronic device from impact damage. An elastic mesh is coupled to the case. The elastic mesh has a plurality of connection points each extending laterally across the case to define a plurality of finger slots in the elastic mesh. Each of the finger slots insertably receives a respective one of a user's fingers for holding the case.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to case devices and more particularly pertains to a new case device for retaining a smart phone case on a user's fingers.

### BRIEF SUMMARY OF THE INVENTION

An embodiment of the disclosure meets the needs presented above by generally comprising a case that has an electronic device removably positioned therein. The case is comprised of a rigid material to protect the electronic device from impact damage. An elastic mesh is coupled to the case. The elastic mesh has a plurality of connection points each extending laterally across the case to define a plurality of finger slots in the elastic mesh. Each of the finger slots insertably receives a respective one of a user's fingers for holding the case.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a back perspective view of a smart phone case assembly according to an embodiment of the disclosure.

FIG. 2 is a back view of an embodiment of the disclosure.

FIG. 3 is a right side view of an embodiment of the disclosure.

FIG. 4 is a top view of an embodiment of the disclosure.

FIG. 5 is a perspective in-use view of an embodiment of the disclosure.

### DETAILED DESCRIPTION OF THE INVENTION

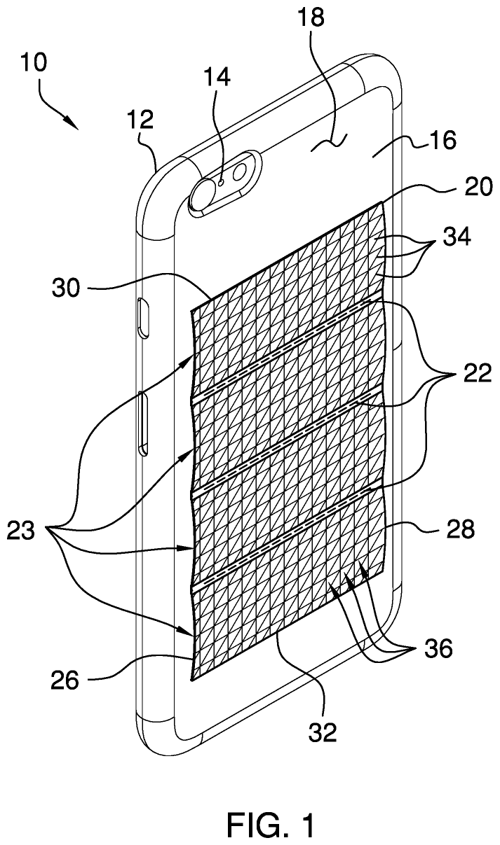

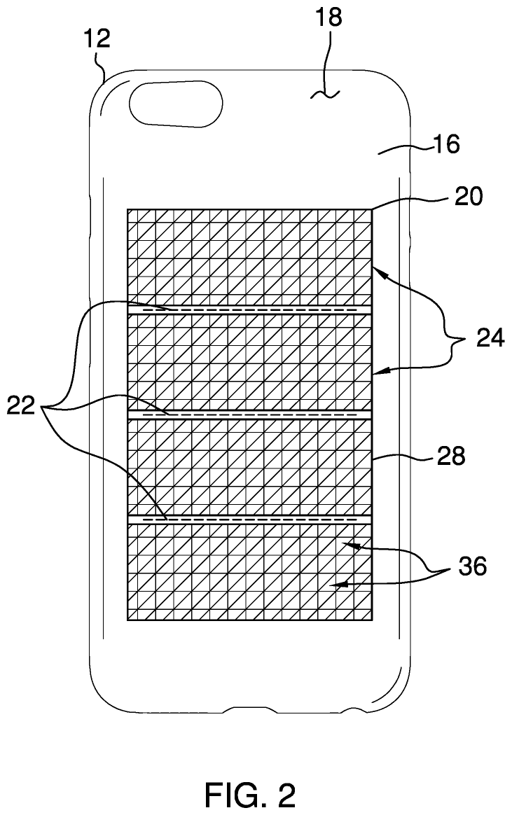

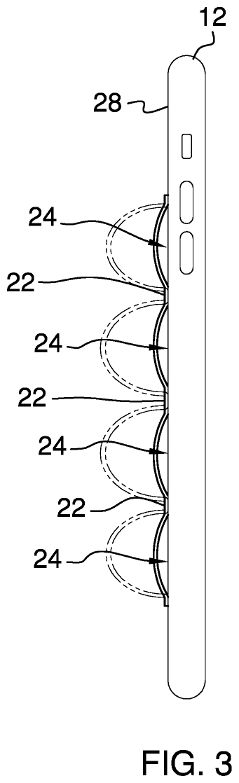

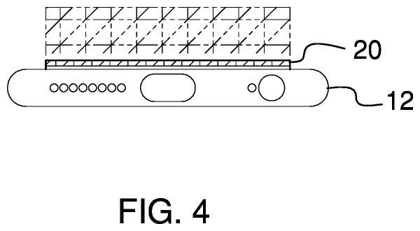

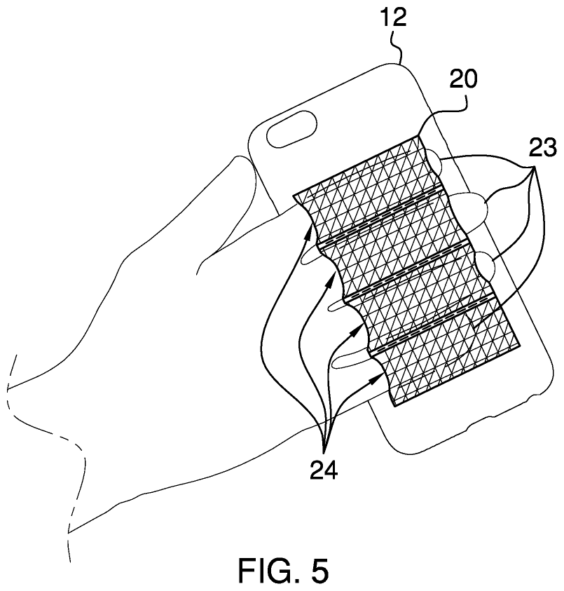

With reference now to the drawings, and in particular to FIGS. 1 through 5 thereof, a new case device embodying the principles and concepts of an embodiment of the disclosure and generally designated by the reference numeral 10 will be described.

As best illustrated in FIGS. 1 through 5, the smart phone case assembly 10 generally comprises a case 12 that has an electronic device 14 removably positioned therein. The electronic device 14 may be a smart phone or the like and the case 12 may be a smart phone case 12 of any conventional design. The case 12 is comprised of a rigid material to protect the electronic device 14 from impact damage. The case 12 has a rear wall 16 and the rear wall 16 has an outwardly facing surface 18.

An elastic mesh 20 is coupled to the case 12 and the elastic mesh 20 has a plurality of connection points 22 each extending laterally across the case 12. The plurality of connection points 22 defines a plurality of finger slots 24 in the elastic mesh 20 to insertably receive a respective one of a user's fingers 23 for holding the case 12. Moreover, the elastic mesh 20 is comprised of a resiliently stretchable material to compress against the user's fingers 23. In this way the elastic mesh 20 inhibits the case 12 from being dropped while the case 12 is being carried.

The elastic mesh 20 has a first lateral edge 26, a second lateral edge 28, a top edge 30 and a bottom edge 32. Each of the top edge 30 and the bottom edge 32 is bonded to the outwardly facing surface 18 of the rear wall 16 of the case 12. Moreover, each of the connection points 22 extends between the first 26 and second 28 lateral edges. The connection points 22 are spaced apart from each other and are distributed between the top edge 30 and the bottom edge 32. The elastic mesh 20 comprises a plurality of intersecting fibers 34, and the plurality of interesting fibers 34 is oriented to define a repeating sequence of triangles 36 distributed over an entirety of the elastic mesh 20.

In use, the user inserts each of the user's fingers 23 into a respective one of the finger slots 24 in the elastic mesh 20. In this way the case 12 is releasably retained on the user's hand without requiring the user to grip the case 12. Thus, the case 12 is inhibited from being dropped regardless of what the user does with their hands. Moreover, the elastic mesh 20 improves the ergonomics involved with holding the case 12 for an extended period of time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A smart phone case assembly having finger sleeves wherein said smart phone case is configured to insertably receive fingers for carrying said smart phone case, said assembly comprising:
a case having an electronic device being removably positioned therein, said case being comprised of a rigid material to protect the electronic device from impact damage; and
an elastic mesh being coupled to said case, said elastic mesh having a plurality of connection points each extending laterally across said case to define a plurality of finger slots in said elastic mesh wherein each of said finger slots is configured to insertably receive a respective one of a user's fingers for holding said case.

2. The assembly according to claim 1, wherein said case has a rear wall, said rear wall having an outwardly facing surface.

3. The assembly according to claim 2, wherein said elastic mesh has a first lateral edge, a second lateral edge, a top edge and a bottom edge, each of said top edge and said bottom edge being bonded to said outwardly facing surface of said rear wall of said case.

4. The assembly according to claim 3, wherein each of said connection points extends between said first and second lateral sides, said connection points being spaced apart from each other and being distributed between said top edge and said bottom edge.

5. The assembly according to claim 1, wherein said elastic mesh comprises a plurality of intersecting fibers, said plurality of interesting fibers being oriented to define a repeating sequence of triangles being distributed over an entirety of said elastic mesh.

6. A smart phone case assembly having finger sleeves wherein said smart phone case is configured to insertably receive fingers for carrying said smart phone case, said assembly comprising:
a case having an electronic device being removably positioned therein, said case being comprised of a rigid material to protect the electronic device from impact damage, said case having a rear wall, said rear wall having an outwardly facing surface; and
an elastic mesh being coupled to said case, said elastic mesh having a plurality of connection points each extending laterally across said case to define a plurality of finger slots in said elastic mesh wherein each of said finger slots is configured to insertably receive a respective one of a user's fingers for holding said case, said elastic mesh having a first lateral edge, a second lateral edge, a top edge and a bottom edge, each of said top edge and said bottom edge being bonded to said outwardly facing surface of said rear wall of said case, each of said connection points extending between said first and second lateral sides, said connection points being spaced apart from each other and being distributed between said top edge and said bottom edge, said elastic mesh comprising a plurality of intersecting fibers, said plurality of interesting fibers being oriented to define a repeating sequence of triangles being distributed over an entirety of said elastic mesh.
